(19) United States
(12) Patent Application Publication
(10) Pub. No.: US 2026/0182564 A1
(43) Pub. Date: Jul. 2, 2026

(54) FLOATING ANTIALGAL-AGENT-LOADED SODIUM ALGINATE HYDROGEL SPHERES, PREPARATION METHOD THEREFOR AND USE THEREOF

(71) Applicant: Sichuan Qinghe Technology Co., Ltd., Chengdu (CN)

(72) Inventors: Feifei Song, Chengdu (CN); Longji Jian, Chengdu (CN); Wenliang Xiang, Chengdu (CN); Yunfeng Zhou, Chengdu (CN); Dongmei Wu, Chengdu (CN); Zihan He, Chengdu (CN)

(21) Appl. No.: 19/288,946

(22) Filed: Aug. 1, 2025

(30) Foreign Application Priority Data
Dec. 31, 2024 (CN) 202411982606.X

(51) Int. Cl. A01N 25/10; A01N 59/20; A01P 13/00

(52) U.S. Cl. CPC A01N 25/10; A01N 59/20; A01P 13/00

(57) ABSTRACT

Disclosed are floating antialgal-agent-loaded sodium alginate hydrogel spheres, a preparation method therefor and use thereof. The preparation method includes preparing a solution A and a solution B; dropwise adding the solution A to the solution B to obtain hydrogel spheres; and filtering and washing to obtain the floating antialgal-agent-loaded sodium alginate hydrogel spheres. The hydrogel spheres may float on the water surface and release copper ions in a low dose for a long time, and continuously inhibit the cyanobacteria on the water surface, with little impact on the water body, which may greatly reduce the risk of water pollution caused by copper ion overdosing. Meanwhile, the hydrogel spheres may effectively reduce the application times of the antialgal agent, reduce the labor cost caused by the long-term application of antialgal agent, float on the water surface for easy recovery, and do not cause secondary pollution to the water body.

### CROSS-REFERENCE TO RELATED APPLICATIONS

This application claims priority to Chinese Patent Application No. 202411982606.X, filed on Dec. 31, 2024, which is hereby incorporated by reference in its entirety.

### TECHNICAL FIELD

The present application relates to floating antialgal-agent-loaded sodium alginate hydrogel spheres, a preparation method therefor and use thereof, and belongs to the technical field of aquatic ecological restoration.

### BACKGROUND

In recent years, the outbreak of cyanobacterial bloom caused by eutrophication has brought many problems. The outbreak of the cyanobacterial bloom leads to the deterioration of the water environment, causing the death of other aquatic organisms and further deteriorating the environment. Cyanobacteria have pseudo-vacuoles, which provide buoyancy and thus regulate distribution of the Cyanobacteria in the water body. When the temperature gradually rises, cyanobacteria gradually rise to the water surface and form algal blooms on the water surface.

At present, the cyanobacterial bloom control technologies include physical, chemical and biological methods. Among them, the chemical cyanobacterial bloom control technology mainly achieves the bloom control effect through chemical algicides and chemical flocculants and has the advantages of high speed and good effect, so that the chemical method is commonly used as an emergency treatment method for the outbreak period of the cyanobacterial bloom.

A copper-based antialgal agent, as one of the chemical antialgal agents, has historically been used for more than 100 years due to their economy, effectiveness, relative safety and ease of operation. The principle of copper-based antialgal agents is mainly that copper ions interfere with the normal metabolism and biochemical reactions of algae by strong affinity to sulfur-containing groups on the surface of the algal cell walls, thereby inhibiting the growth of algae. Copper-based antialgal agents at typical application concentrations (0.025-1 ppm) are considered to have no significant adverse effects on human health. According to China's National Surface Water Environmental Quality Standards, the maximum allowable copper concentration in Class II to V water bodies is 1 ppm. Therefore, copper-based antialgal agents have become a research focus for researchers in this field.

Chinese Patent Application Publication No. CN118833897A discloses a method for improving an algae removal effect of copper-loaded biochar. A particle size of copper-loaded biochar particles is increased using inorganic salt ions, which improves the contact efficiency between the copper-loaded biochar and the algae, and increases the salt stress and cell membrane damage of algae cells, thereby improving the algae removal efficiency. Although this antialgal agent can improve algal removal efficiency, excessive application often occurs during cyanobacterial bloom treatment, potentially causing secondary pollution to water bodies. In practice, multiple small-dose applications are typically adopted to mitigate this risk. However, this approach requires substantial labor and material resources. Furthermore, this antialgal agent still presents several drawbacks: short effective duration, prolonged dosing cycles, and the risk of overdosing that may lead to heavy metal contamination in both water bodies and sediments.

### SUMMARY

In view of the foregoing defects, the first technical problem resolved by the present application is to provide a preparation method for novel floating antialgal-agent-loaded sodium alginate hydrogel spheres capable of long-term sustained release.

The preparation method for floating antialgal-agent-loaded sodium alginate hydrogel spheres includes the following steps:
1) preparing a solution A and a solution B, where the solution A consists of sodium alginate, citrate, an acidic pH regulator, hydrogen peroxide and water; the solution B consists of copper(II) sulfate pentahydrate, citrate, an acidic pH regulator and water;
2) adding the solution A dropwise into the solution B, stirring during the addition, and standing after the addition is complete to obtain hydrogel spheres; and
3) filtering out the hydrogel spheres, washing and removing copper sulfate on a surface of the hydrogel spheres, and obtaining the floating antialgal-agent-loaded sodium alginate hydrogel spheres.

In an embodiment of the present application, in the step 1), the citrate is trisodium citrate or copper citrate; and the acidic pH regulator is citric acid.

In an embodiment of the present application, in the step 1), the citrate is trisodium citrate; and the acidic pH regulator is citric acid.

In an embodiment of the present application, in the solution A in the step 1), a mass concentration of the hydrogen peroxide is 1%-4%, a concentration of the sodium alginate is 0.5-2.5 g/100 mL, a concentration of the trisodium citrate is 0.74-5.88 g/100 mL, and a concentration of the citric acid is 0.53-4.2 g/100 mL; in the solution B, a concentration of the copper(II) sulfate pentahydrate is 5-37 g/100 mL, a concentration of the trisodium citrate is 0.74-5.88 g/100 mL, and a concentration of the citric acid is 0.53-4.2 g/100 mL.

In a preferred embodiment of the present application, in the solution A, a mass concentration of the hydrogen peroxide is 3%-4%, a concentration of the sodium alginate is 1.5-2 g/100 mL, a concentration of the trisodium citrate is 1.47-2.94 g/100 mL, and a concentration of the citric acid is 1.05-2.1 g/100 mL; in the solution B, a concentration of the copper(II) sulfate pentahydrate is 30-37 g/100 mL, a concentration of the trisodium citrate is 1.47-2.94 g/100 mL, and a concentration of the citric acid is 1.05-2.1 g/100 mL.

In a preferred embodiment of the present application, in the solution A, a mass concentration of the hydrogen peroxide is 3.5%, a concentration of the sodium alginate is 2 g/100 mL, a concentration of the trisodium citrate is 1.47 g/100 mL, and a concentration of the citric acid is 1.05 g/100 mL; in the solution B, a concentration of the copper(II) sulfate pentahydrate is 35 g/100 mL, a concentration of the trisodium citrate is 1.47 g/100 mL, and a concentration of the citric acid is 1.05 g/100 mL.

In an embodiment of the present application, in the step 2), a volume ratio of the solution A to the solution B is 1:2.

The second technical problem resolved by the present application is to provide floating antialgal-agent-loaded sodium alginate hydrogel spheres.

The floating antialgal-agent-loaded sodium alginate hydrogel spheres are prepared by the method described above. The floating antialgal-agent-loaded sodium alginate hydrogel spheres are a novel copper-based floating sustained-release agent capable of long-term sustained release, which may float on the water surface and release copper ions at a low dose for a long time. Compared with traditional copper-based antialgal agents, this floating sustained-release agent may enable continuous inhibition of cyanobacteria on the water surface, which may greatly reduce the risk of water pollution caused by copper ion overdosing, and also reduce the labor cost caused by long-term application of antialgal agents.

The present application further provides use of the floating antialgal-agent-loaded sodium alginate hydrogel spheres in the treatment of cyanobacterial bloom.

The floating antialgal-agent-loaded sodium alginate hydrogel spheres may be used to treat cyanobacterial bloom and have a sustained-release effect, which effectively reduces the application times of the antialgal agent and has little impact on the water body. In addition, the floating antialgal-agent-loaded sodium alginate hydrogel spheres have intrinsic floatability, so that the recovery is facilitated, and the secondary pollution to the water body is avoided.

Compared with the prior art, the present application has the following beneficial effects:

The present application prepares novel floating antialgal-agent-loaded sodium alginate hydrogel spheres by a specific preparation method. The hydrogel spheres float on the water surface and release copper ions in a low dose for a long time, and continuously inhibit the cyanobacteria on the water surface, with little impact on the water body, which may greatly reduce the risk of water pollution caused by copper ion overdosing. Meanwhile, the hydrogel spheres may effectively reduce the application times of the antialgal agent, and also reduce the labor cost caused by the long-term application of antialgal agent. In addition, the hydrogel spheres float on the water surface for easy recovery and do not cause secondary pollution to the water body.

### BRIEF DESCRIPTION OF DRAWINGS

FIG. 1 is a morphological diagram of floating antialgal-agent-loaded sodium alginate hydrogel spheres prepared in Examples 1 and 2 according to the present application, where the left panel is floating antialgal-agent-loaded sodium alginate hydrogel spheres prepared in Example 1, and the right panel is floating antialgal-agent-loaded sodium alginate hydrogel spheres prepared in Example 2.

FIG. 2 is a graph of a release capacity of Cu²⁺ of the floating antialgal-agent-loaded sodium alginate hydrogel spheres prepared in Examples 1 and 2 according to the present application in pure water.

FIG. 3 is a diagram of effects of different concentrations of hydrogen peroxide on gas-induced flotation of sodium alginate hydrogel spheres in Example 4, where the concentrations of the hydrogen peroxide from left to right are 3%, 3.5%, and 4%, respectively.

FIG. 4 is a graph of changes in chlorophyll and copper content over time in an experiment of cyanobacteria inhibition by hydrogel spheres in Example 5.

### DETAILED DESCRIPTION OF EMBODIMENTS

The preparation method for floating antialgal-agent-loaded sodium alginate hydrogel spheres includes the following steps:
1) preparing a solution A and a solution B, where the solution A consists of sodium alginate, citrate, an acidic pH regulator, hydrogen peroxide and water; the solution B consists of copper(II) sulfate pentahydrate, citrate, an acidic pH regulator and water;
2) adding the solution A dropwise into the solution B, stirring during the addition, and standing after the addition is complete to obtain hydrogel spheres; and
3) filtering out the hydrogel spheres, washing and removing copper sulfate on a surface of the hydrogel spheres, and obtaining the floating antialgal-agent-loaded sodium alginate hydrogel spheres.

This method is simple and easy to operate, has low raw material cost, and may successfully prepare floating antialgal-agent-loaded sodium alginate hydrogel spheres with a sustained-release function.

In an embodiment of the present application, in the step 1), the citrate is trisodium citrate or copper citrate; and the acidic pH regulator is citric acid.

In an embodiment of the present application, in the step 1), the citrate is trisodium citrate; and the acidic pH regulator is citric acid.

The copper sulfate of the present application is copper(II) sulfate pentahydrate, the trisodium citrate is trisodium citrate dihydrate, and the citric acid is citric acid monohydrate.

The copper(II) sulfate pentahydrate is the main active ingredient, which is used to release copper ions in water. The trisodium citrate reacts in the sodium alginate microenvironment to generate copper citrate, so as to reduce the release rate of copper ions in the hydrogel spheres. The citric acid adjusts the pH in the sodium alginate microenvironment. The sodium alginate is used to complex with copper ions to form the hydrogel spheres. The hydrogen peroxide is used to decompose to generate gas in the hydrogel spheres and make the hydrogel spheres float. The floating antialgal-agent-loaded sodium alginate hydrogel spheres with a good sustained-release function is finally obtained with the cooperation of all the substances. Instead of the hydrogen peroxide, other substances that may decompose to generate gas may be used. For example, when sodium bicarbonate is used, citric acid monohydrate should not be added to the sodium alginate solution. This makes the microenvironment in the hydrogel spheres alkaline, which easily causes the copper ions to react to form copper hydroxide and basic copper carbonate, thereby impeding the release of copper ions. Meanwhile, the gas-generating component in the hydrogel spheres is carbon dioxide. The high aqueous solubility of the carbon dioxide shortens the flotation duration of the hydrogel spheres and thus affects the floating performance of the hydrogel spheres.

In an embodiment of the present application, in the solution A in the step 1), a mass concentration of the hydrogen peroxide is 1%-4%, a concentration of the sodium alginate is 0.5-2.5 g/100 mL, a concentration of the trisodium citrate is 0.74-5.88 g/100 mL, and a concentration of the citric acid is 0.53-4.2 g/100 mL; in the solution B, a concentration of the copper(II) sulfate pentahydrate is 5-37 g/100 mL, a concentration of the trisodium citrate is 0.74-5.88 g/100 mL, and a concentration of the citric acid is 0.53-4.2 g/100 mL.

In a preferred embodiment of the present application, in the solution A, a mass concentration of the hydrogen peroxide is 3%-4%, a concentration of the sodium alginate is 1.5-2 g/100 mL, a concentration of the trisodium citrate is 1.47-2.94 g/100 mL, and a concentration of the citric acid is 1.05-2.1 g/100 mL; in the solution B, a concentration of the copper(II) sulfate pentahydrate is 30-37 g/100 mL, a concentration of the trisodium citrate is 1.47-2.94 g/100 mL, and a concentration of the citric acid is 1.05-2.1 g/100 mL.

In a preferred embodiment of the present application, in the solution A, a mass concentration of the hydrogen peroxide is 3.5%, a concentration of the sodium alginate is 2 g/100 mL, a concentration of the trisodium citrate is 1.47 g/100 mL, and a concentration of the citric acid is 1.05 g/100 mL; in the solution B, a concentration of the copper(II) sulfate pentahydrate is 35 g/100 mL, a concentration of the trisodium citrate is 1.47 g/100 mL, and a concentration of the citric acid is 1.05 g/100 mL.

In an embodiment of the present application, in the step 2), a volume ratio of the solution A to the solution B is 1:2.

The floating antialgal-agent-loaded sodium alginate hydrogel spheres are prepared by the method described above. The floating antialgal-agent-loaded sodium alginate hydrogel spheres are a novel copper-based floating sustained-release agent capable of long-term sustained release, which may float on the water surface and release copper ions at a low dose for a long time. Compared with traditional copper-based antialgal agents, this floating sustained-release agent may enable continuous inhibition of cyanobacteria on the water surface, which may greatly reduce the risk of water pollution caused by copper ion overdosing, and also reduce the labor cost caused by long-term application of antialgal agents.

The present application further provides use of the floating antialgal-agent-loaded sodium alginate hydrogel spheres in the treatment of cyanobacterial bloom.

The floating antialgal-agent-loaded sodium alginate hydrogel spheres may be used to treat cyanobacterial bloom and have a sustained-release effect, which effectively reduces the application times of the antialgal agent and has little impact on the water body. In addition, the floating antialgal-agent-loaded sodium alginate hydrogel spheres have intrinsic floatability, so that the recovery is facilitated, and the secondary pollution to the water body is avoided.

The specific implementations of the present application are further described below in conjunction with examples, but the present application is not limited to the scope of the examples.

### Example 1

10 g of 30% hydrogen peroxide solution was weighed and diluted with 90 g of water to prepare 100 g of 3.0% hydrogen peroxide solution. Then, 1.47 g (5 mmol) of trisodium citrate dihydrate and 1.05 g (5 mmol) of citric acid monohydrate were added to the hydrogen peroxide solution and stirred to dissolve. Finally, 2 g of sodium alginate was added and stirred to dissolve to obtain a solution A for later use.

10 g of copper sulfate pentahydrate, 2.94 g of trisodium citrate dihydrate, and 2.1 g of citric acid monohydrate were weighed and dissolved in 200 g of water to obtain a solution B for later use.

The solution A was added dropwise into the solution B under constant gentle stirring to obtain floating hydrogel spheres. After the addition of the solution A was completed, stirring was stopped and the solution was allowed to stand for 2 h to allow for full complexation.

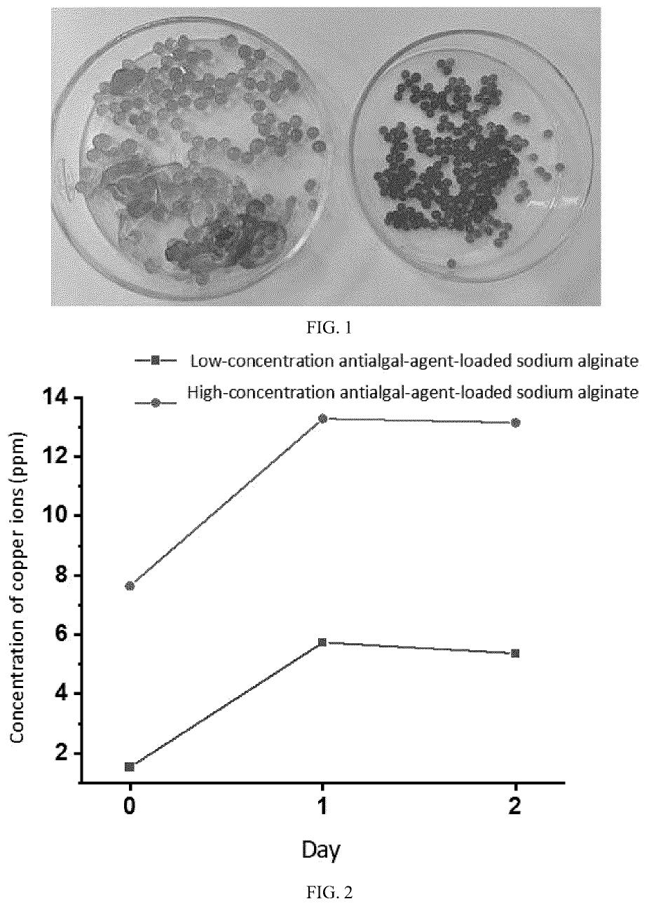

The hydrogel spheres were filtered out and washed three times with 600 mL of ultrapure water to remove the copper sulfate solution on the surface, thereby obtaining the final floating antialgal-agent-loaded sodium alginate hydrogel spheres, the morphology of which is shown in FIG. 1.

### Example 2

10 g of 30% hydrogen peroxide solution was weighed and diluted with 90 g of water to prepare 100 g of 3.0% hydrogen peroxide solution. Then, 1.47 g (5 mmol) of trisodium citrate dihydrate and 1.05 g (5 mmol) of citric acid monohydrate were added to the hydrogen peroxide solution and stirred to dissolve. Finally, 2 g of sodium alginate was added and stirred to dissolve to obtain a solution A for later use.

70 g of copper sulfate pentahydrate, 2.94 g of trisodium citrate dihydrate, and 2.1 g of citric acid monohydrate were weighed and dissolved in 200 g of water to obtain a solution B for later use.

The solution A was added dropwise into the solution B under constant gentle stirring to obtain floating hydrogel spheres. After the addition of the solution A was completed, stirring was stopped and the solution was allowed to stand for 2 h to allow for full complexation.

The hydrogel spheres were filtered out and washed three times with 600 mL of ultrapure water to remove the copper sulfate solution on the surface, thereby obtaining the final floating antialgal-agent-loaded sodium alginate hydrogel spheres, the morphology of which is shown in FIG. 1.

In FIG. 1, the left panel shows the floating antialgal-agent-loaded sodium alginate hydrogel spheres prepared in Example 1 (i.e., the low concentration group), and the right panel shows the floating antialgal-agent-loaded sodium alginate hydrogel spheres prepared in Example 2 (i.e., the high concentration group). It may be seen from FIG. 1 that, under the same time, the sodium alginate hydrogel spheres complexed under the condition of high-concentration copper sulfate are darker in color, which indicates that the sodium alginate hydrogel spheres carry more copper ions.

0.5 g of each of the floating antialgal-agent-loaded sodium alginate hydrogel spheres prepared in Example 1 and Example 2 was taken and soaked in 500 g of ultrapure water, and the change of Cu²⁺ concentration in the water was monitored. The results are shown in FIG. 2.

It may be seen from FIG. 2 that, the initial Cu²⁺ concentration and the concentration released within one day of the sodium alginate hydrogel spheres complexed from the high-concentration copper sulfate solution are greater than those of the hydrogel spheres complexed from the low-concentration copper sulfate solution. Therefore, the final concentration of the copper sulfate solution is set at 35 g/100 mL.

### Example 3

Referring to the method of Example 2, only the concentration of sodium alginate in the solution A was changed, and the floating antialgal-agent-loaded sodium alginate hydrogel spheres were obtained. The copper ion loading in the hydrogel spheres was calculated by measuring the change in copper ion concentration in copper sulfate solution using atomic absorption. The calculation method is as follows:

$$Loading capacity = \frac{{C}_{1} * {V}_{1} - {C}_{2} * {V}_{2} - {C}_{3} * {V}_{3}}{m}$$

C₁: copper ion concentration in the solution B;
C₂: copper ion concentration in the filtrate obtained after the hydrogel sphere are filtered out;
C₃: copper ion concentration in the washing solution obtained after the hydrogel spheres are washed;
V₁: volume of the solution B;
V₂: volume of the filtrate obtained after the hydrogel spheres are filtered out;
V₃: volume of the washing solution obtained after the hydrogel spheres are washed;
m: mass of the hydrogel spheres after washing.

The experimental results are shown in Table 1.

TABLE 1

| | | | | |
|---|---|---|---|---|
| Concentration of sodium | 1.0 | 1.5 | 2.0 | 2.5 |
| alginate (g/100 mL) | | | | |
| Copper ion loading capacity | 38.74 | 47.77 | 64.69 | 43.57 |
| (mg/g) | | | | |

It may be seen that, when the concentration of the sodium alginate is 2.0 g/100 mL, the copper ion loading capacity of the prepared hydrogel spheres is the highest, so the concentration of the sodium alginate is preferably set to 2.0 g/100 mL.

### Example 4

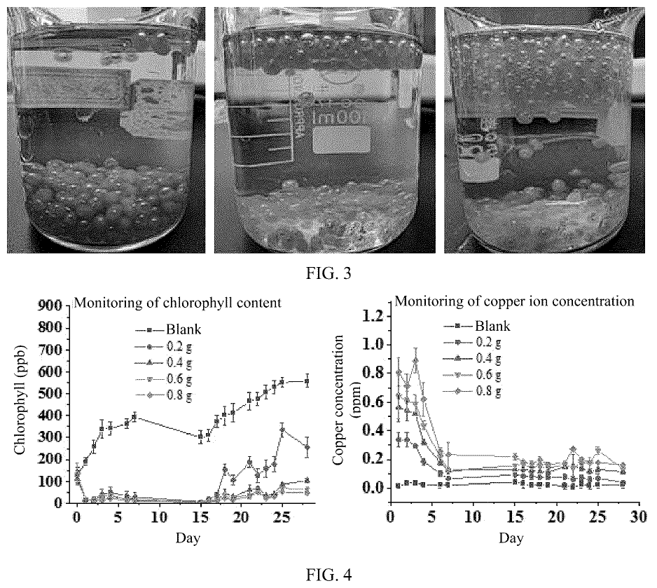

Three concentrations of hydrogen peroxide (3.0%, 3.5%, and 4.0%) were used to prepare floating antialgal-agent-loaded sodium alginate hydrogel spheres. The amounts of other components added and the preparation method in Example 4 were the same as in Example 2. The concentration of hydrogen peroxide added was determined by observing the floating of the hydrogel spheres after 2 hours. The effects of three concentrations of hydrogen peroxide on the gas-induced flotation of sodium alginate hydrogel spheres are shown in FIG. 3.

It may be seen from FIG. 3 that the addition of 3% of 30% hydrogen peroxide is not enough to make the hydrogel spheres float in water; with the addition of 3.5%, half of the hydrogel spheres may float, and the sinking hydrogel spheres may also gradually float up after gradually releasing copper ions and decreasing their density; and with the addition of 4%, most of the hydrogel spheres may float, but some of the hydrogel spheres generate excessive gas to cause fracture and sinking. Therefore, the final concentration of hydrogen peroxide added is set at 3.5%.

### Example 5

15 red pots were taken and placed outdoors, and 8.5 L of algae-turbid water was added to each pot. The dominant algae specie in the water was Microcystis. The 15 pots were equally divided into three groups. Different masses of hydrogel spheres prepared in Example 2 were placed in each group. No hydrogel spheres were placed in the blank group. 500 mL of water sample was taken out every day, and 500 mL of algae-turbid water was newly added. The changes in content of chlorophyll and concentration of copper ions in each group were monitored every day. The results are shown in Table 2, Table 3 and FIG. 4.

TABLE 2
Monitoring of chlorophyll concentration (unit: ppb)

| | | | 0.2 g | | 0.4 g | | 0.6 g | | 0.8 g | |
|---|---|---|---|---|---|---|---|---|---|---|
| | Blank | | (23.5 g/m³) | | (47.1 g/m³) | | (70.6 g/m³) | | (94.1 g/m³) | |
| | | Standard | | Standard | | Standard | | Standard | | Standard |
| Day | Mean | deviation | Mean | deviation | Mean | deviation | Mean | deviation | Mean | deviation |
| 0 | 129.467 | 16.903 | 127.213 | 38.744 | 111.773 | 19.202 | 132.167 | 22.890 | 132.387 | 50.500 |
| 1 | 189.820 | 17.213 | 14.340 | 4.719 | 15.603 | 1.115 | 15.753 | 0.837 | 14.932 | 8.581 |
| 2 | 258.867 | 29.308 | 19.950 | 7.668 | 14.377 | 1.931 | 14.707 | 3.401 | 14.600 | 7.153 |
| 3 | 338.630 | 42.366 | 41.207 | 22.876 | 33.770 | 12.827 | 33.323 | 4.787 | 14.711 | 5.407 |
| 4 | 340.920 | 29.283 | 50.603 | 21.797 | 31.060 | 11.776 | 37.450 | 5.896 | 21.697 | 4.798 |
| 6 | 363.837 | 23.721 | 33.067 | 19.098 | 19.280 | 3.312 | 15.750 | 3.549 | 13.077 | 2.671 |
| 7 | 393.223 | 21.517 | 28.830 | 18.388 | 16.380 | 3.432 | 18.053 | 3.006 | 12.073 | 1.034 |
| 15 | 300.616 | 30.281 | 5.869 | 3.794 | 3.864 | 1.012 | 2.749 | 0.422 | 4.310 | 1.036 |
| 16 | 310.247 | 27.434 | 19.280 | 7.798 | 9.994 | 0.715 | 10.103 | 1.785 | 10.104 | 0.724 |
| 17 | 374.233 | 25.153 | 40.087 | 9.736 | 16.160 | 2.560 | 16.007 | 2.288 | 12.220 | 1.346 |
| 18 | 400.163 | 40.746 | 153.530 | 26.411 | 44.360 | 22.317 | 38.453 | 9.000 | 23.370 | 3.169 |
| 19 | 414.167 | 42.657 | 105.697 | 23.255 | 30.057 | 5.666 | 25.710 | 3.532 | 15.563 | 1.735 |
| 21 | 465.317 | 39.435 | 187.643 | 24.111 | 61.977 | 24.479 | 38.973 | 6.897 | 30.390 | 11.722 |
| 22 | 475.327 | 29.423 | 128.120 | 32.721 | 69.577 | 6.191 | 57.480 | 9.808 | 50.673 | 3.208 |
| 23 | 507.067 | 32.801 | 158.050 | 38.576 | 34.650 | 5.210 | 24.170 | 4.710 | 22.573 | 2.707 |
| 24 | 531.220 | 30.525 | 177.900 | 35.340 | 43.347 | 2.374 | 38.773 | 6.539 | 30.373 | 2.658 |
| 25 | 551.277 | 22.963 | 334.967 | 31.863 | 87.057 | 3.211 | 67.897 | 4.834 | 52.173 | 9.325 |
| 28 | 558.080 | 29.945 | 256.997 | 47.246 | 103.583 | 10.261 | 64.633 | 7.579 | 46.357 | 7.401 |

TABLE 3
Monitoring of copper ion concentration (unit: ppm)

| | | | 0.2 g | | 0.4 g | | 0.6 g | | 0.8 g | |
|---|---|---|---|---|---|---|---|---|---|---|
| | Blank | | (23.5 g/m³) | | (47.1 g/m³) | | (70.6 g/m³) | | (94.1 g/m³) | |
| | | Standard | | Standard | | Standard | | Standard | | Standard |
| Day | Mean | deviation | Mean | deviation | Mean | deviation | Mean | deviation | Mean | deviation |
| 1 | 0.013 | 0.015 | 0.337 | 0.049 | 0.563 | 0.098 | 0.640 | 0.151 | 0.810 | 0.098 |
| 2 | 0.037 | 0.015 | 0.337 | 0.050 | 0.543 | 0.075 | 0.607 | 0.065 | 0.713 | 0.085 |
| 3 | 0.037 | 0.012 | 0.293 | 0.006 | 0.517 | 0.006 | 0.590 | 0.062 | 0.890 | 0.086 |
| 4 | 0.020 | 0.010 | 0.183 | 0.021 | 0.320 | 0.020 | 0.437 | 0.031 | 0.620 | 0.118 |
| 6 | 0.020 | 0.020 | 0.103 | 0.021 | 0.177 | 0.015 | 0.217 | 0.025 | 0.257 | 0.023 |
| 7 | 0.020 | 0.010 | 0.067 | 0.015 | 0.123 | 0.021 | 0.123 | 0.015 | 0.233 | 0.087 |
| 15 | 0.043 | 0.015 | 0.093 | 0.012 | 0.133 | 0.015 | 0.157 | 0.006 | 0.220 | 0.020 |
| 16 | 0.030 | 0.026 | 0.083 | 0.012 | 0.130 | 0.017 | 0.163 | 0.025 | 0.183 | 0.006 |
| 17 | 0.023 | 0.015 | 0.083 | 0.025 | 0.127 | 0.021 | 0.143 | 0.012 | 0.170 | 0.020 |
| 18 | 0.020 | 0.020 | 0.077 | 0.015 | 0.117 | 0.006 | 0.153 | 0.012 | 0.197 | 0.025 |
| 19 | 0.023 | 0.015 | 0.077 | 0.015 | 0.113 | 0.006 | 0.140 | 0.017 | 0.167 | 0.015 |
| 21 | 0.017 | 0.021 | 0.080 | 0.017 | 0.150 | 0.010 | 0.163 | 0.015 | 0.177 | 0.012 |
| 22 | 0.010 | 0.017 | 0.063 | 0.021 | 0.153 | 0.084 | 0.143 | 0.006 | 0.273 | 0.017 |
| 23 | 0.023 | 0.023 | 0.073 | 0.021 | 0.143 | 0.021 | 0.170 | 0.000 | 0.200 | 0.010 |
| 24 | 0.017 | 0.021 | 0.063 | 0.021 | 0.120 | 0.020 | 0.177 | 0.038 | 0.177 | 0.012 |
| 25 | 0.020 | 0.017 | 0.070 | 0.030 | 0.130 | 0.017 | 0.263 | 0.021 | 0.177 | 0.006 |
| 28 | 0.020 | 0.017 | 0.040 | 0.000 | 0.113 | 0.012 | 0.137 | 0.006 | 0.163 | 0.006 |

It may be seen from the experimental results that the experimental groups have a good inhibitory effect on cyanobacteria, the inhibition time reaches more than 14 days, and the inhibition time of the groups with copper ion concentrations of 0.6 g and 0.8 g may reach more than 21 days. The concentration of copper ions used in each group does not exceed 1 ppm, and gradually decreases and is stabilized during the continuous water changes, without causing the problem of excessive copper ion concentration in the water body.

What is claimed is:

1. A preparation method for floating antialgal-agent-loaded sodium alginate hydrogel spheres, comprising the following steps:
1) preparing a solution A and a solution B, wherein the solution A consists of sodium alginate, citrate, an acidic pH regulator, hydrogen peroxide and water; the solution B consists of copper(II) sulfate pentahydrate, citrate, an acidic pH regulator and water; the citrate is trisodium citrate; and the acidic pH regulator is citric acid;
2) adding the solution A dropwise into the solution B, stirring during the addition, and standing after the addition is complete to obtain hydrogel spheres; and
3) filtering out the hydrogel spheres, washing and removing copper sulfate on a surface of the hydrogel spheres, and obtaining the floating antialgal-agent-loaded sodium alginate hydrogel spheres; wherein
in the solution A in the step 1), a mass concentration of the hydrogen peroxide is 3.5%-4%, a concentration of the sodium alginate is 1.5-2 g/100 mL, a concentration of the trisodium citrate is 1.47-2.94 g/100 mL, and a concentration of the citric acid is 1.05-2.1 g/100 mL; and
in the solution B, a concentration of the copper(II) sulfate pentahydrate is 30-37 g/100 mL, a concentration of the trisodium citrate is 1.47-2.94 g/100 mL, and a concentration of the citric acid is 1.05-2.1 g/100 mL.

2. The preparation method for the floating antialgal-agent-loaded sodium alginate hydrogel spheres according to claim 1, wherein in the solution A, the mass concentration of the hydrogen peroxide is 3.5%; the concentration of the sodium alginate is 2 g/100 mL; the concentration of the trisodium citrate is 1.47 g/100 mL, and the concentration of the citric acid is 1.05 g/100 mL;
in the solution B, the concentration of the copper(II) sulfate pentahydrate is 35 g/100 mL, the concentration of the trisodium citrate is 1.47 g/100 mL, and the concentration of the citric acid is 1.05 g/100 mL.

3. The preparation method for the floating antialgal-agent-loaded sodium alginate hydrogel spheres according to claim 1, wherein in the step 2), a volume ratio of the solution A to the solution B is 1:2.

4. Floating antialgal-agent-loaded sodium alginate hydrogel spheres prepared by the preparation method for the floating antialgal-agent-loaded sodium alginate hydrogel spheres according to claim 1.

5. Use of the floating antialgal-agent-loaded sodium alginate hydrogel spheres according to claim 4 in the treatment of cyanobacterial bloom.
